(19) United States
(12) Patent Application Publication
(10) Pub. No.: US 2012/0224867 A1
(43) Pub. Date: Sep. 6, 2012

(54) METHOD AND APPARATUS FOR ALL-OPTICAL DISCRETE FOURIER TRANSFORM INCLUDING ALL-OPTICAL OFDM DEMULTIPLEXING

(75) Inventor: Inuk Kang, Freehold, NJ (US)

(73) Assignee: ALCATEL-LUCENT USA INC., Murray Hill, NJ (US)

(21) Appl. No.: 13/040,784

(22) Filed: Mar. 4, 2011

(51) Int. Cl. H04B 10/06

(52) U.S. Cl. 398/202

(57) ABSTRACT

Various exemplary embodiments relate to an optical discrete Fourier transform device including: a 1×N splitter; N optical delay lines each with an optical phase shifter, wherein the N optical delay lines are coupled to the 1×N MMI device; and an N×N MMI device coupled to the N optical delay lines, wherein the N×N MMI device produces N optical outputs.

### TECHNICAL FIELD

Various exemplary embodiments disclosed herein relate generally to a method and apparatus for an all-optical discrete Fourier transform.

### BACKGROUND

Optical orthogonal frequency division multiplexing (OFDM) has received much attention as a promising technique in supporting transport capacity beyond 100 Gb/s. Especially, coherent-optical (CO)-OFDM has been established as a viable candidate for 100-Gb/s transmission. It is also recognized that CO-OFDM is a powerful tool not only for tightly packaging multiple subcarriers complying with the ITU grid, but also for combining multiple high-rate coherent channels into a super-channel carrying >Tb/s traffic.

### SUMMARY

The superb transmission performance of optical OFDM is due in part to the advancement of high-speed digital signal processing for computationally compensating for various transmission penalties. The high-speed electronic processing, however, has a drawback of high power consumption, which increases with increasing processing speed.

The prevailing method of optical orthogonal frequency division multiplexing (OFDM) uses electronic signal processing for demultiplexing using discrete Fourier transform. A significant drawback of such technique is high electrical power consumption. An all-optical means for demultiplexing OFDM signals is desired for reduced power consumption, which is becoming an important issue in next-generation optical networks. There are several propositions that have been made thus far to implement OFDM demultiplexing all-optically using fiber gratings, cascaded Mach-Zehnder interferometers, or star couplers. These prior solutions suffer from large device size or/and complex controls to implement the discrete Fourier transform.

In light of the present need for an all-optical discrete Fourier transform device, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in the later sections.

Various exemplary embodiments provide an optical discrete Fourier transform device including: a 1×N splitter; N optical delay lines each with an optical phase shifter, wherein the N optical delay lines are coupled to the 1×N splitter; and an N×N MMI device coupled to the N optical delay lines, wherein the N×N MMI device produces N optical outputs.

Various exemplary embodiments further provide a method of computing an optical discrete Fourier transform of an input optical signal, including: splitting the input optical signal into N optical signals; delaying each of the N optical signals; phase shifting each of the N optical signals; and transforming the N optical signals into N output optical signals using an N×N MMI device.

Various exemplary embodiments relate to an optical communication system including: an optical frequency division multiplexing (OFDM) modulator that produces an optical OFDM signal having N channels; a transmission optical fiber receiving and transmitting the optical OFDM signal; and an optical discrete Fourier transform device coupled to the transmission optical fiber that receives the optical OFDM signal, wherein the optical discrete Fourier transform device further includes: a 1×N splitter; N optical delay lines each with an optical phase shifter, wherein the N optical delay lines are coupled to the 1×N MMI device; and an N×N MMI device coupled to the N optical delay lines, wherein the N×N MMI device produces N optical outputs.

### BRIEF DESCRIPTION OF THE DRAWINGS

In order to better understand various exemplary embodiments, reference is made to the accompanying drawings, wherein:

FIG. 1 illustrates an embodiment of the all-optical discrete Fourier transform device;

FIG. 2 illustrates a N×N MMI device according to an embodiment of the all-optical discrete Fourier transform device;

FIG. 3 illustrates a 4×4 MMI device according to an embodiment of the all-optical discrete Fourier transform device; and

FIG. 4 illustrates an embodiment of an all-optical OFDM communication system.

### DETAILED DESCRIPTION

Referring now to the drawings, in which like numerals refer to like components or steps, there are disclosed broad aspects of various exemplary embodiments.

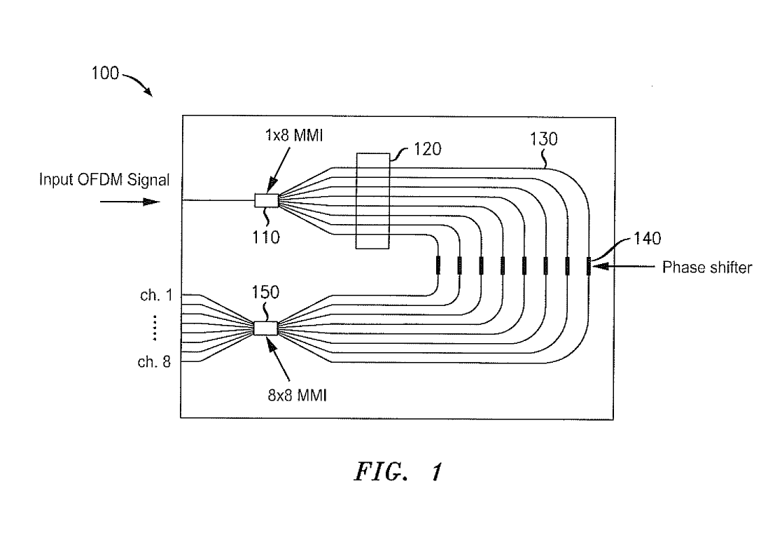

FIG. 1 illustrates an embodiment of the all-optical discrete Fourier transform device 100. The all-optical discrete Fourier transform device 100 may include a 1×N multi-mode interference (MMI) device 110, variable optical attenuators (VOAs) 120, N optical delay lines 130, N optical phase shifters 140, and an N×N MMI device. In the example illustrated in FIG. 1, N=8.

The 1×N MMI device 110 acts as an optical splitter by splitting an input optical signal into N output optical signals having equal power. If the 1×N MMI device does not output sufficiently uniform output signals, then VOAs 120 may be used to adjust the N output signals to reduce the variations in the N output signals. The VOAs 120 may also be used to compensate for other amplitude variations due to the optical delay lines 130, optical phase shifts 140, or any other components. The VOAs 120 may be set at the time of manufacture to compensate for variations in the 1×N MMI device or other variation. Further, the all-optical discrete Fourier transform device 100 may measure the outputs of the 1×N MMI device or other components during operation to control the VOAs 120. Other, 1×N splitters may be used as well.

N optical delay lines carry the N optical signals from the 1×N MMI device to the N×N MMI optical device. The delay lines each incrementally delay a transmitted optical signal by time duration T. Therefore, optical delay line n may delay the transmitted optical signal by (n−1)T relative to the delay induced by delay line 1. Further, each delay line includes a phase shifter 140 that shifts the phase of the optical signal on the optical delay line 130. The phase shifters 140 may include feedback to compensate for variations in the phase shifters 140 or the delay lines 130 due to various factors, such as temperature, aging, etc. Any optical phase shifter may be used.

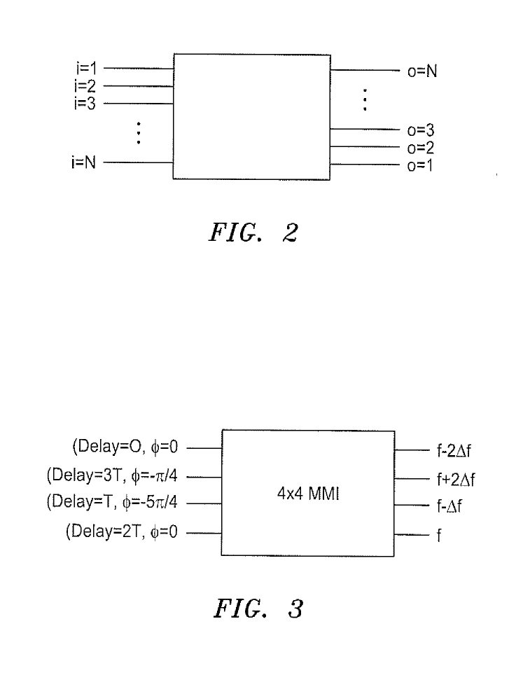

The N×N MMI device uses the optical Talbot effect occurring in MMIs to compute a discrete Fourier transform efficiently. Thus, the input/output relationship of the MMI can be used to implement the discrete Fourier transform. This can then be used to simultaneously demultiplex all the sub-carrier channels in an OFDM signal. The operation of the N×N MMI device will be further explained with respect to FIG. 2.

FIG. 2 illustrates an N×N MMI device according to an embodiment of the all-optical discrete Fourier transform device. The N×N MMI device can be described in matrix terms, ideally, by means of a transfer matrix A which describes the connections between the input and output signals of the device. The relationship between the input and output optical signals is given by the vector equation

Eₒ=AE,

where E(n) represents the complex optical field magnitude at input port n, and Eₒ(n) is the complex optical field magnitude at output port n. The elements of the transfer matrix are given by

A_{i,o}=a_{i,o} exp(jφᵢₒ)

where aᵢₒ is the amplitude coefficient and φᵢₒ is the phase shift. For an ideal MMI, aᵢₒ is 1 for all i and all o. The phase relationship of the MMI can be described as,

$${φ}_{i , o} = π + \frac{π}{4 N} ( o - i ) ( 2 N - o + i ) \qquad if ( i + o ) = even ;$$

$${φ}_{i , o} = \frac{π}{4 N} ( i + o - 1 ) ( 2 N - i - o + i ) \qquad if ( i + o ) = odd .$$

By using this phase relationship, temporal delays and phase offsets applied by the optical delay lines 130 and the phase shifters 140 may be calculated such that the signals output from the MMI correspond to the discrete Fourier Transform of the optical signal input to the 1×N MMI device. If the input optical signal at the 1×N MMI device is an optical OFDM signal, then the outputs of the N×N MMI device are the N demultiplexed OFDM sub-channels.

The first operation required to determine the phase shift to be applied by the phase shifters 140 is rearrangement of phase components of the rows of the matrix A to generate a new matrix Ã with the following conditions

\tilde{φ}_{i,o}=φ_{2i-1,o} for i≦|N/2|,
where |N/2| is the ceiling function of N/2.

\tilde{φ}_{i,o}=φ_{2(N+1-i),o} for i>|N/2|

Using the first column of the modified matrix, a phase offset Δφᵢ may be defined corresponding to the signal path having (i−1)T relative temporal delay:

Δφᵢ=−\tilde{φ}ᵢ₁

Note that similar offset vectors can be defined using different columns. This would result in different but equivalent wiring of the discrete Fourier transform device 100.

Then, it can be shown that

$${E}_{o} = {\sum }_{i = 1}^{N} E ( t - ( i - 1 ) T ) {e}^{jΔφ} , {e}^{j {\tilde{φ}}_{i , o}}$$

is the discrete Fourier transform equation demultiplexing the OFDM signal F(t) into N sub-carrier components (o=1, 2, . . . , N). The frequency components are related such that the o-th output waveguide selects the frequency component

fₒ=f₁−(−1)^{o}└o/2┘Δf,

where └o/2┘ is the floor of o/2 and Δf=1/NT.

These equations define how the temporal delay lines leading to the N×N MMI should be wired and also specify the static phase offset of each delay line. Namely, i-th delay line (having (i−1)T delay) should be connected to the k-th input waveguides of a MMI, following

k=2i−1 for i≦|N/2|,
where |N/2| is the ceiling function of N/2.

k=2(N+1−i) for i≧|N/2|.

FIG. 3 provides a specific example of a 4×4 MMI device. The first through fourth input signals will have the following delay and phase shifts respectively: (0, 0); (3T, −π/4); (T, −5π/4); and (2T, 0). When these delays and phase shifts are applied, the 4×4 MMI device outputs the demultiplexed OFDM input signals at the output as shown in FIG. 3. Note that FIG. 3 corresponds to the wiring of delay lines (0, T, 2T, 3T) to the N×N input waveguides (1, 3, 4, 2) according to the equation in [0015]. However, other equivalent connections are allowed owing to the symmetry of the equations. More specifically, any circular reordering of the input waveguides is allowed. Hence, such permutation as (2, 1, 3, 4), (3, 4, 2, 1), (3, 1, 2, 4) are allowed.

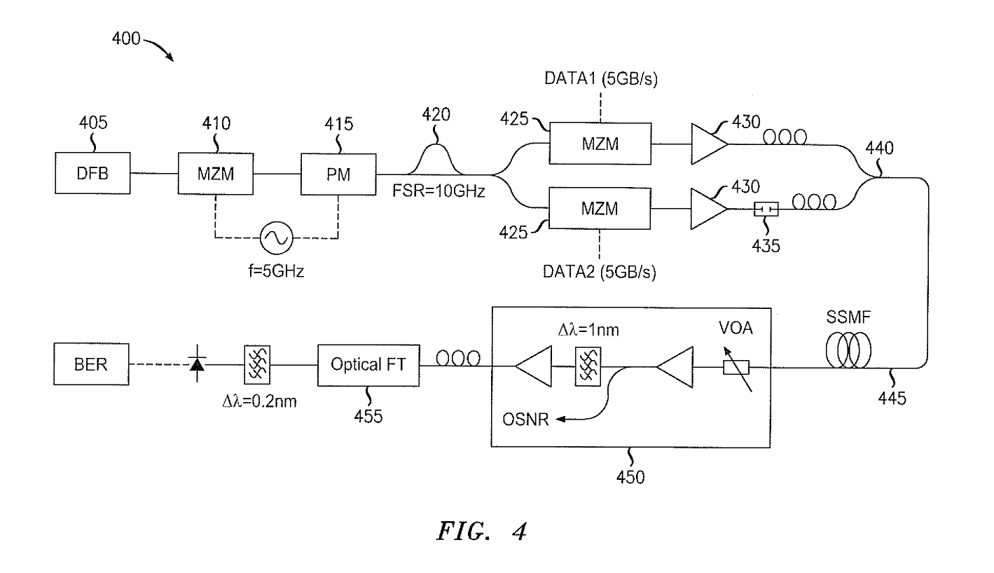

FIG. 4 illustrates an embodiment of an all-optical OFDM communication system 400. First optical frequency combs are generated by sinusoidally modulating a distributed feedback (DFB) laser 405 output using a Mach-Zehnder modulator (MZM) 410 followed by a phase modulator (PM) 415. The generated combs are split into two sets using a 10-GHz free spectral range (FSR) delay line interferometer 420. Each comb set is modulated using two MZMs 425 by 5-Gb/s NRZ OOK input data that are decorrelated with each other. After optical amplification 430 to compensate for the optical losses in the modulators 425, the two data streams are polarization and time aligned 435 before being combined by a PM coupler 440 and then launched into standard single mode fiber (SSMF) 445. After transmission through SSMF 445, the optical signal is amplified by a two-stage amplifier 450 and sent to the all-optical FT device 455. The outputs of the all-optical FT device 445 are the demultiplexed OFDM input signals.

The use of the MMI devices allow for decreased power consumption and results in a more compact system. Further, the all-optical OFDM system does not require the conversion of optical signals to electrical signals for demodulation. This allows for a less complex OFDM system.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

1. An optical discrete Fourier transform device comprising:
a 1×N splitter;
N optical delay lines each with an optical phase shifter, wherein the N optical delay lines are coupled to the 1×N splitter; and
an N×N multi-mode interference (MMI) device coupled to the N optical delay lines.

2. The device of claim 1, wherein the splitter is a 1×N MMI device.

3. The device of claim 1, wherein the i^{th} optical delay line has incremental time delay (i−1)T.

4. The device of claim 1, wherein the N phase shifters are configured to apply a phase shift −\tilde{φ}ᵢₒ where the value of o is fixed and where
\tilde{φ}_{i,o}=φ_{2i-1,o} for i≦|N/2|,
where |N/2| is the ceiling function of N/2.
\tilde{φ}_{i,o}=φ_{2(N+1-i),o} for i>|N/2|

and where
$${φ}_{i , o} = π + \frac{π}{4 N} ( o - i ) ( 2 N - o + i ) \qquad if ( i + o ) = even ;$$
$${φ}_{i , o} = \frac{π}{4 N} ( i + o - 1 ) ( 2 N - i - o + i ) \qquad if ( i + o ) = odd , and$$
wherein the i-th delay line having (i−1)T delay is coupled to the k-th input of the N×N MMI device according to,
k=2i−1 for i≦|N/2|,
where |N/2| is the ceiling function of N/2,
k=2(N+1−i) for i≧|N/2|.

5. The device of claim 4, wherein the coupling of the i delay lines to the k inputs of the N×N device are circularly reordered.

6. The device of claim 1, wherein when the 1×N MMI device receives an optical orthogonal frequency division multiplexing (OFDM) signal the N×N MMI device outputs optical demultiplexed OFDM optical signals.

7. The device of claim 1, further comprising a variable optical attenuator that attenuates the outputs of the 1×N splitter.

8. A method of computing an optical discrete Fourier transform of an input optical signal, comprising:
splitting the input optical signal into N optical signals;
delaying each of the N optical signals;
phase shifting each of the N optical signals; and
transforming the N optical signals into N output optical signals using an N×N MMI device.

9. The method of claim 8, wherein the splitter is a 1×N MMI device.

10. The method of claim 8, wherein the i^{th} optical delay line has incremental time delay (i−1)T.

11. The method of claim 8, wherein the N phase shifters apply a phase shift −\tilde{φ}ᵢₒ where the value of o is fixed and where
\tilde{φ}_{i,o}=φ_{2i-1,o} for i≦|N/2|,
where |N/2| is the ceiling function of N/2,
\tilde{φ}_{i,o}=φ_{2(N+1-i),o} for i>|N/2|

and where
$${φ}_{i , o} = π + \frac{π}{4 N} ( o - i ) ( 2 N - o + i ) \qquad if ( i + o ) = even ;$$
$${φ}_{i , o} = \frac{π}{4 N} ( i + o - 1 ) ( 2 N - i - o + i ) \qquad if ( i + o ) = odd , and$$
wherein the i-th delay line having (i−1)T delay is coupled to the k-th input of the N×N MMI device according to,
k=2i−1 for i≦|N/2|,
where |N/2| is the ceiling function of N/2,
k=2(N+1−i) for i≧|N/2|.

12. The device of claim 11, wherein the coupling of the i delay lines to the k inputs of the N×N device, are circularly reordered.

13. The method of claim 8, wherein the input optical signal is an optical orthogonal frequency division multiplexing (OFDM) signal and wherein the N output optical signals are demultiplexed OFDM optical signals.

14. The method of claim 8, further comprising applying variable attenuation to the N optical signals.

15. An optical communication system comprising:
an optical frequency division multiplexing (OFDM) modulator that produces an optical OFDM signal having N sub-channels;
a transmission optical fiber receiving and transmitting the optical OFDM signal; and
an optical discrete Fourier transform device coupled to the transmission optical fiber that receives the optical OFDM signal, wherein the optical discrete Fourier transform device further comprises:
a 1×N splitter;
N optical delay lines each with an optical phase shifter, wherein the N optical delay lines are coupled to the splitter; and
an N×N multi-mode interference (MMI) device coupled to the N optical delay lines.

16. The device of claim 15, wherein the splitter is a 1×N MMI device.

17. The device of claim 15, wherein the i^{th} optical delay line has incremental time delay (i−1)T.

18. The device of claim 15, wherein the N phase shifters are configured to apply a phase shift −\tilde{φ}ᵢₒ where the value of o is fixed and where
\tilde{φ}_{i,o}=φ_{2i-1,o} for i≦|N/2|,
where |N/2| is the ceiling function of N/2,
\tilde{φ}_{i,o}=φ_{2(N+1-i),o} for i>|N/2|

and where
$${φ}_{i , o} = π + \frac{π}{4 N} ( o - i ) ( 2 N - o + i ) \qquad if ( i + o ) = even ;$$
$${φ}_{i , o} = \frac{π}{4 N} ( i + o - 1 ) ( 2 N - i - o + i ) \qquad if ( i + o ) = odd , and$$
wherein the i-th delay line having (i−1)T delay is coupled to the k-th input of the N×N MMI device according to,
k=2i−1 for i≦|N/2|,
where |N/2| is the ceiling function of N/2,
k=2(N+1−i) for i≧|N/2|.

19. The device of claim 18, wherein the coupling of the i delay lines to the k inputs of the N×N device, are circularly reordered.

20. The device of claim 15, the optical discrete Fourier transform device further comprising a variable optical attenuator that attenuates the outputs of the 1×N splitter device.
